(19) United States
(12) Patent Application Publication
(10) Pub. No.: US 2026/0225576 A1
(43) Pub. Date: Aug. 6, 2026

(54) METHOD FOR OPERATING A RANGE EXTENDER OF A MOTOR VEHICLE, CORRESPONDING CONTROL DEVICE AND CORRESPONDING MOTOR VEHICLE

(71) Applicant: AUDI AG, Ingolstadt (DE)

(72) Inventor: Felix WINKELMEYR, lngolstadt (DE)

(21) Appl. No.: 19/462,815

(22) Filed: Jan. 28, 2026

(30) Foreign Application Priority Data
Jan. 30, 2025 (DE) 102025103381.1

(51) Int. Cl. B60W 20/12; B60K 6/46; B60L 50/62; B60W 10/06; B60W 10/08; B60W 10/26; B60W 20/13; B60W 20/16; B60W 50/00

(52) U.S. Cl. CPC B60W 20/12; B60K 6/46; B60L 50/62; B60W 10/06; B60W 10/08; B60W 10/26; B60W 20/13; B60W 20/16; B60W 50/0097; B60W 2510/244; B60W 2556/10; B60W 2556/50; B60W 2710/06; B60W 2710/083; B60W 2710/244; B60Y 2200/92; B60Y 2300/91

(57) ABSTRACT

A method for operating a range extender of a motor vehicle is disclosed and may include , generating a drive torque by a traction motor of the motor vehicle using electrical energy stored in an energy storage device of the motor vehicle, charging the energy storage device by operation of an internal combustion engine of a range extender using a fossil fuel and by use of a generator of the range extender, determining or recording a route plan relating to a route to be taken during a journey with the motor vehicle before or at a start of the journey, determining an operating plan relating to the charging of the energy storage device during the journey by way of the range extender based on the route plan, and executing the journey while implementing the operating plan. The traction motor may be configured as an electrical machine.

### BACKGROUND

### TECHNICAL FIELD

The present disclosure relates to a method for operating a range extender of a motor vehicle.

### DESCRIPTION OF THE RELATED ART

Electromobility is becoming increasingly important in connection with motor vehicles. Electric vehicles or hybrid vehicles are often used as motor vehicles. Such motor vehicles comprise an electric machine implementing an electric motor, by way of which a drive torque is generated and transmitted to a drive train. The energy required for this purpose is stored as electrical energy in an electrical energy storage device or a battery, which is converted into kinetic energy for the vehicle by way of the electric motor. In electric vehicles, drive torque is generated solely on the basis of the electrical energy stored in the energy storage device. In hybrid vehicles, the drive torque is also generated by an internal combustion engine.

A widespread problem associated with such motor vehicles is the limited range resulting from capacity issues relating to the energy storage device. To implement a range extension, a range extending device is proposed in the state of the art, which is often also referred to as a range extender. The range extender typically comprises an internal combustion engine and a generator, wherein the internal combustion engine is operated using a fossil fuel to drive the generator, and the electrical energy generated by the generator is used to charge the energy storage device. One problem that arises here relates to the generation of exhaust gases or pollutants due to combustion in the internal combustion engine.

To address this problem, CN110816308A proposes to determine a current position of the motor vehicle by way of a navigation device at a time when the range extender is to be started due to a low state of charge of the energy storage device. The activation of the range extender takes into account a circumstance that can be determined based on the current position, such as whether the vehicle is currently located in residential areas or the like.

### BRIEF SUMMARY

The present disclosure sets forth an improved concept for operation of a range extender, in particular with regard to the problem of pollutants being emitted.

According to the present disclosure, a motor vehicle is disclosed having an electrical energy storage device for storing electrical energy and a traction motor configured as an electrical machine, by way of which electrical energy stored in the energy storage device may be used to generate a drive torque of the motor vehicle, wherein the motor vehicle includes a range extender comprising an internal combustion engine and a generator. The energy storage device may be charged by way of the operation of the internal combustion engine using a fossil fuel and use of the generator. A method for operating the route extender of the motor vehicle may include determining or acquiring a route plan relating to a route to be travelled by motor vehicle before or at the beginning of an upcoming journey, wherein an operating plan relating to the charging of the energy storage device during the journey by way of the range extender is determined on the basis of the route plan. The journey may be carried out in implementation of the operating plan.

The present disclosure utilizes the route planning that typically occurs anyway, such that the most advantageous strategy for determining whether and when the range extender should be activated can be established in advance by determining the operating plan. The use of the route plan according to the present disclosure enables consideration of the complete, predictive driving course and not only, as is the case, for example, in the aforementioned CN110816308A, of a current state. Predictive states relating to the environment through which the motor vehicle travels, as well as to the motor vehicle itself, may be taken into account.

As described above, the range extender comprises the combustion engine and the generator. During the operation of the internal combustion engine, fossil fuel, for example gasoline or diesel, which is taken from a fuel tank of the vehicle, is burned, which in turn may lead to a movement or rotation that is transmitted, for example via a shaft, to a rotor of the generator. The rotation of the rotor in turn may lead to the generation of electrical energy, which may be supplied to the vehicle’s energy storage system for charging purposes and therefore correspondingly to extend the range.

The electrical energy storage device, which may also be referred to as a battery or an accumulator, may be a lithium-ion battery, for example. A direct voltage provided by the energy storage device may be converted into an alternating voltage by way of a voltage converter, which in turn may be supplied to the electric machine or traction motor, resulting in movement or rotation of a rotor of the traction motor. The rotor is connected to a drive train of the motor vehicle in such a way that this movement or rotation may be transmitted to the wheels of the motor vehicle via shafts, gears and the like, thus realizing a drive torque.

In some embodiments, the route plan contains information relating to a route or distance to be traveled as part of the upcoming journey. In some embodiments, the route plan may also comprise information relating to the topography, i.e., an elevation profile, of the route. Furthermore, the route plan may take into account or contain traffic information relating to, for example, existing speed limits and/or a current traffic situation. In some embodiments, the route plan also comprises temporal information relating to the progression of driving the route by motor vehicle over time. In other words, the route plan may comprise information about when and where the vehicle is expected to be at which point on the route.

The determination of the operating plan according to the present disclosure may comprise, the determination of at least one start time and, optionally, at least one duration of connecting the range extender. In other words, at least one charging section of the route may be determined, which represents the section of the route during which the range extender may be operated during the journey.

During the journey, the determined operating plan may be implemented or realized. This means, in particular, that control occurring on the part of the motor vehicle may cause the range extender to be connected at the start time and for the duration specified in the operating plan.

In some embodiments, at least one connection section of the route, in which the charging of the energy storage device by way of the range extender is feasible due to a pollutant emission of the combustion engine compared to the remaining part of the route, may be identified on the basis of the route plan. The operating plan may be determined in such a way that a charging section of the route, within which the energy storage device may be charged by way of the range extender, takes place at least largely or completely within the at least one connection section. In the context of this embodiment, sections of the route may be classified according to whether it is advantageous to connect the range extender in the respective section, for example, because in such a section, which is referred to as the connection section, there are no limitations or restrictions with regard to pollutant emissions and/or no or at least only minimal negative effects are to be expected due to pollutant emissions. In some embodiments, the at least one connection section may be identified in such a way that the at least one connection section is located outside a populated area and/or a low emission zone. The route plan may provide information as to whether the section in question is a populated area, i.e., a town, village or housing estate, or a low emission zone. Low emission zones are areas in which, by official order, only vehicles that comply with certain emission standards are allowed to drive.

In some embodiments, the operating plan is determined by carrying out an optimization problem in which the portion of the charging section that falls within the at least one connection section is the variable to be maximized. The optimization problem may be based on variable and determinable input variables, such that an optimization variable, which depends on the input variables, has the best possible value. The input variables here may be variables that are to be determined in the course of determining the operating plan.

The optimization variable here may be the portion of the charging section that also falls within the connection section. The greater the portion of the charging section that falls within the at least one connection section, the shorter the period of time during which the range extender may be operated outside the connection section and the fewer pollutants are emitted due to the operation of the range extender in sections of the route that are outside the connection section. Preferably, a time, such as a start time, and a duration of the at least one charging section may be the variables of the optimization problem to be determined.

In some embodiments, the route plan may be used to predict a progression of the state of charge of the energy storage device along the route over time, on the basis of which the operating plan is determined. The progression of the state of charge over time may be available as a data set or can be generated as a data set in which different points in time and/or locations on the route are each assigned an associated value for the state of charge. The state of charge, which is often referred to as SoC (“State of Charge”), is typically given as a percentage. A state of charge of 0% means that the energy storage device is completely discharged. A charge level of 100% means that the energy storage device is fully charged. To determine the progression of the state of charge over time, an initial state of charge may be determined and used, which indicates the state of charge at the start of the journey.

The progression of the state of charge over time may be determined using an average energy consumption of the vehicle, which may be based on historical data and/or empirical values. In some embodiments, the history data may be used for this purpose, which was recorded and stored, for example, during previous journeys, especially along the route currently being traveled. In addition, data on energy consumption may be stored and retrieved with regard to empirical values, which may depend on current driving conditions. The driving conditions may be, for example, the speed and/or acceleration of the motor vehicle and/or topographical features of the route.

According to the present disclosure, the operating plan may be determined such that the energy storage device is only charged during the journey by way of the range extender if the state of charge during the journey is not always greater than a predetermined charge limit value. In this case, it may be assumed that the electrical energy stored by the energy storage device at the start of the journey is sufficient to complete the entire journey and that it is therefore not necessary to connect the range extender and therefore the corresponding pollutant emissions is not necessary. The charge limit value may be specified such that a certain buffer of electrical energy remaining in the energy storage device when the charging limit value is reached is ensured. For example, the charge limit value may have a value between 5% and 30%, in particular 10%.

The charge limit value may be fixed. In some embodiments, the charge limit value may be changed. For example, the charge limit value may be one of the variables to be determined in the course of carrying out the optimization problem discussed above. For example, the charge limit value may be lowered to a hard, lower limit, such as 5%. A drop in the charge limit value may result in a starting point for connecting the range extender being postponed so that the connecting falls into a connection section. Increasing the charge limit value, on the other hand, may lead to a starting point for connecting the range extender being brought forward in time so that the corresponding operation of the range extender takes place entirely within a connection section.

The route plan may be determined using a navigation device. The navigation device must be GPS-based. This enables the user to specify a target position at the start of the journey. The route planning may then be carried out by calculating a fastest and/or shortest route from the current position of the motor vehicle, which may be determined using corresponding GPS data, for example. The navigation device may be a component of the motor vehicle.

In some embodiments, the route plan comprises at least one charging station located along the route, wherein a possible charging of the energy storage device at the charging station is taken into account to determine the operating plan. To avoid connecting the range extender, the route plan may comprise charging the energy storage device during a stop at the charging station.

The motor vehicle may have an input device by way of which a user may preset a specification relating to at least one user request directed to the operating plan, the operating plan being determined taking into account the at least one user request. This allows the user or driver of the vehicle to specify preferences regarding the creation of the operating plan, which are taken into account when the operating plan is created. In some embodiments, several conceivable options may be provided with regard to the operating plan, which, for example, represent equivalent solutions to the optimization problem, wherein the final selection of the operating plan to be implemented is based on the desire of the user.

In some embodiments, if there are several possible operating plans, one of which provides for charging the energy storage device at the charging station, one of these operating plans is selected based on the preference of the user. For example, one of the operating plans may involve a stop at the charging station and another of the operating plans may involve connecting the range extender instead, wherein the user may specifically choose which of these variants they prefer within the scope of the preference of the user. This is particularly useful because stopping at the charging station is associated with a loss of time, so that the user, for example if they are under time pressure, may wish to connect the range extender instead.

Furthermore, the present disclosure relates to a control device for a motor vehicle, wherein the motor vehicle comprises an electrical energy storage device for storing electrical energy and a traction motor designed as an electrical machine, by way of which electrical energy stored in the energy storage device can be used to generate a drive torque of the motor vehicle. The motor vehicle comprises a range extender comprising an internal combustion engine and a generator, wherein the energy storage device may be charged by way of the operation of the internal combustion engine using a fossil fuel and use of the generator. In accordance with the present disclosure, such a control device is configured to carry out the method according to the preceding description. In some embodiments, the control device is configured to generate and output control signals, such as output control signals to the range extender, in such a way that the journey is carried out while implementing the operating plan. All the features, advantages and aspects discussed in connection with the method according to the present disclosure are equally transferable to the control device according to the present disclosure and vice versa.

In some embodiments, the steps of the method according to the present disclose may be carried out by way of software implemented by the control device, wherein the software utilizes artificial intelligence, such as trained artificial intelligence. The control device may be connected to the components involved via signal lines. The control device may comprise a computer-readable storage medium and a processing device, wherein the storage medium comprises instructions realizing the software which, when executed by way of the processing device formed as a computer, cause it to perform the corresponding method steps.

The control device may be a component of the electrical machine, which is intended for control thereof. In this way, the motor vehicle may effectively be retrofitted with regard to the present disclosure by implementing the software on an already existing control device, which implements a corresponding engine control unit.

Furthermore, the present disclosure relates to a motor vehicle comprising an electrical energy storage device for storing electrical energy and a traction motor designed as an electric machine, by way of which electrical energy stored in the energy storage device may be used to generate a drive torque of the motor vehicle, wherein the motor vehicle comprises a range extender comprising an internal combustion engine and a generator. The energy storage device may be charged by way of the operation of the internal combustion engine using a fossil fuel and use of the generator. According to the present disclosure, such a motor vehicle may comprise a control device according to the preceding description passages. All the advantages, features and aspects discussed in connection with the control device according to the present disclosure are equally transferable to the method according to the present disclosure and vice versa.

### BRIEF DESCRIPTION OF THE SEVERAL VIEWS OF THE DRAWINGS

FIG. 1 is a side view of a motor vehicle comprising a control device according to the present disclosure according to an exemplary embodiment.

FIG. 2 is a flow chart of a method according to the present disclosure in accordance with an exemplary embodiment, which is carried out in the motor vehicle of FIG. 1.

FIG. 3 is a schematic representation of an exemplary route plan determined in the course of carrying out the method of FIG. 2.

FIG. 4 is a representation of a state of charge over time of an electrical energy storage device of the motor vehicle of FIG. 1, which is determined in accordance with a first conceivable operating plan determined in the course of carrying out the method of FIG. 2.

FIG. 5 is a representation of a state of charge over time of an electrical energy storage device of the motor vehicle of FIG. 1, which is determined in accordance with a second conceivable operating plan determined in the course of carrying out the method of FIG. 2.

### DETAILED DESCRIPTION

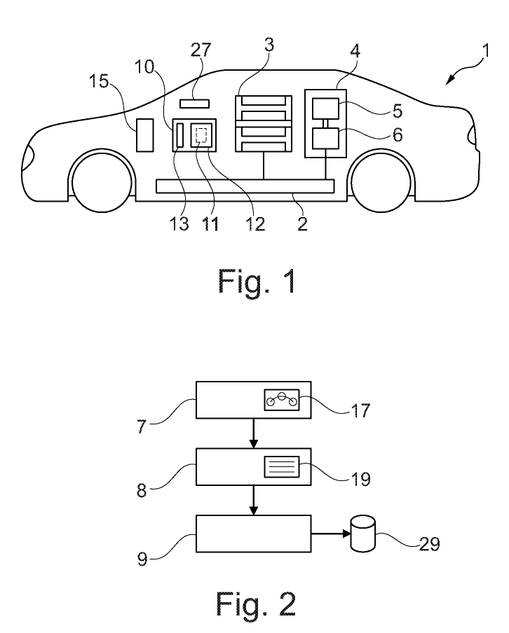

FIG. 1 shows a schematic, lateral representation of a motor vehicle 1 according to the present disclosure, which is configured as an electric vehicle and has an electrical energy storage device 2, which may be configured as a lithium-ion accumulator for storing electrical energy and a traction motor 3 configured as an electric machine. By way of the traction motor 3, electrical energy stored in the energy storage device 2 may be used to generate a drive torque for the motor vehicle 1. A rotor of the traction motor 3 may accordingly be connected to a drive train of the motor vehicle 1, which is not shown in detail in FIG. 1.

The motor vehicle 1 comprises a range extender 4 with an internal combustion engine 5 and a generator 6. The energy storage device 2 may be recharged by operating the internal combustion engine 5, which uses a fossil fuel from a fuel tank of the motor vehicle 1. For this purpose, the internal combustion engine 5 may drive a rotor of the generator 6, wherein the electrical energy generated in this way may be transferred from the generator 6 to the electrical energy storage device 2.

With reference to the flow chart shown in FIG. 2, a method according to the present disclosure is discussed below in accordance with an exemplary embodiment that is carried out on the motor vehicle 1. To carry out steps 7, 8, 9 of this method, a control device 10 according to the present disclosure may be provided and configured in accordance with an exemplary embodiment, which may be a component of the motor vehicle 1 and which may be connected to the corresponding components involved via signal lines not shown in detail in the figures. Specifically, the process steps 7, 8, 9 may be carried out by way of software 11 implemented by the control device 10, wherein the software 11 may implement a trained artificial intelligence. The control device 10 comprises a computer-readable storage medium 12 and a processing device 13, wherein the storage medium 12 comprises instructions realizing the software 11 which, when executed by the processing device 13 formed as a computer, cause it to perform the corresponding method steps. In some embodiments, the control device 10 is a controller having a microprocessor that includes a processor and a memory storing instructions that, when executed by the processor, cause the microprocessor to perform the acts of the control device 10 described herein. The control device 10 may be a component of the electric machine or traction motor 3 and may implement a corresponding engine control unit. Such a configuration enables retrofitting of the motor vehicle 1 with regard to the present disclosure by way of a subsequent implementation of software 11.

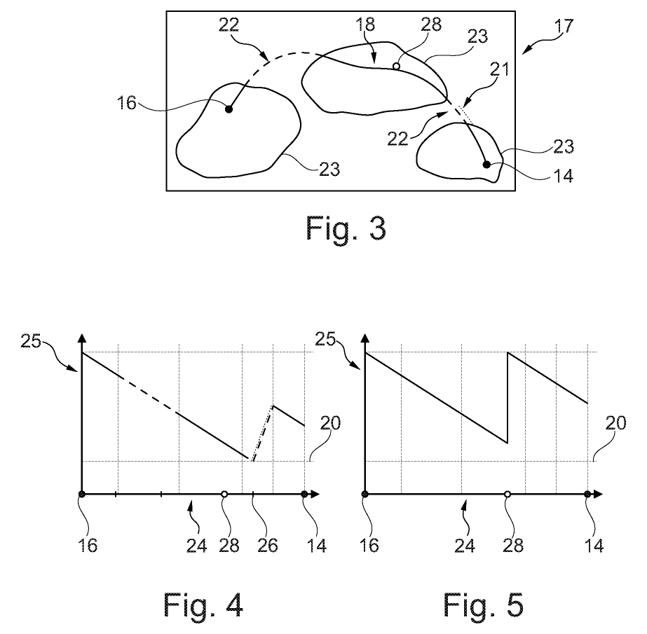

With regard to the first step 7, a journey with the motor vehicle 1 is imminent at the step 7. A destination 14 may be specified by a user or driver of the motor vehicle 1. A GPS-based navigation device 15 of the motor vehicle 1 may be used to determine a current position 16 of the motor vehicle 1. The destination 14 and the current position 16 may be used to determine a route plan 17 for a route 18 to be taken to complete this journey. The route plan 17 is shown as an example in the form of a schematic map in FIG. 3.

In the next step 8 of the method, the route plan 17 may be used to determine an operating plan 19 for charging the energy storage device 2 during the journey using the range extender 4. For this purpose, an expected progression of a state of charge of the energy storage device 2 over time may be first determined if it is assumed that the energy storage device 2 is not charged. To determine this progression, the state of charge of the energy storage device 2 is determined at the start of the journey, which in this example shown in the figures is 100%, i.e., the energy storage device 2 is fully charged. This determination may also be based on a known average energy consumption of the vehicle 1 or the energy storage device 2 based on historical data and empirical values.

For this purpose, historical data may be used that was recorded and stored during previous journeys along the route 18 currently being traveled. In addition or alternatively, data for the required energy consumption may be stored and retrieved with regard to the empirical values, which depend on the expected speeds, accelerations and topographical characteristics of the route 18 that are known or predicted in the route plan 17.

This progression may be used to determine whether the expected state of charge is always greater than a specified charge limit value 20, which may be 10% for example. In this case, the operating plan 19 may be specified in such a way that the energy storage device 2 is not recharged during the journey by way of the range extender 4 in order to avoid pollutant emissions. In the example embodiment shown in the figures, however, it is assumed that the electrical energy stored in the energy storage device 2 at the start of the journey is not sufficient to complete the entire journey and that the charge limit value 20 would therefore be undershot.

In this case, the operating plan 19 provides that a charging section 21 of the route 18, within which the energy storage device 2 may be charged by way of the range extender 4, is specified. Specific details regarding the determination or specification of the charging section 21 are discussed below.

For example, the route plan 17 may be first used to determine connection sections 22 of the route 18 in which the charging of the energy storage device 2 by way of the range extender 4 should preferably be carried out with respect to the other sections of the route 18 for reasons based on pollutant emissions of the range extender 4. The connection sections 22 may be determined in such a way that they are located outside populated areas 23 and outside low emission zones, which can be seen in FIG. 3, in which the populated areas 23 or towns through which the route 18 passes are shown. The connection sections 22 are indicated by dashed lines. The charging section 21, which is located in the second of the two determined connection sections 22, is indicated by a dotted line.

For further discussion of the determination of the charging section 21, reference is henceforth made to FIG. 4, which shows a coordinate system relating to the expected state of charge of the energy storage device 2 during the implementation or realization of the operating plan 19. The abscissa 24 of this coordinate system refers to the distance traveled along route 18. Alternatively, the abscissa 24 may refer to the time elapsed since the start of the journey. The ordinate 25 of the coordinate system relates to the state of charge of the energy storage device 2, i.e., the SoC.

A multi-dimensional optimization problem is carried out to determine the charging section 21. The variable to be optimized, i.e., maximized, is the portion of the charging section 21 or the sum of all charging sections 21 that fall within the connection sections 22. The aim is therefore to minimize the operation of the range extender 4 outside the connection sections 22. The variables to be determined in the context of this optimization problem are a start time 26, at which the operation of the range extender 4 begins, and a duration of the subsequent charging section 21.

A boundary condition of the optimization problem relates to the aforementioned charge limit value 20, which must not be undershot during the entire driving time. Nevertheless, the charge limit value 20 may in principle also represent a further variable that is determined as part of the solution to the optimization problem. Although the charge limit value 20 is always 10% in the example embodiment shown in the figures, the charge limit value 20 may be changed within certain limits if this results in a further improvement in the optimization variable. These limits are such that the charge limit value 20 must not fall below a value of 5%, for example.

If there are several equivalent solutions to the optimization problem, further boundary conditions may be specified, for example that the state of charge of the energy storage device 2 should be as high as possible at the end of the journey. In principle, if there are several equivalent solutions to the optimization problem, each of which represents a possible operating plan 19, one of these solutions may be selected at random.

A further, optional aspect is discussed below, which may be provided when carrying out the method. Thus, the motor vehicle 1 may comprise an input device 27, which is, for example, a touchscreen arranged on a dashboard of the motor vehicle 1. The input device 27 may enable the user to specify a user request relating to the operating plan 19, which may then be taken into account in the course of determining the final operating plan 19 to be implemented.

In the example embodiment shown in the figures, the user request relates to the fact that a charging station 28 located along the route 18 was identified as part of the route plan 17. FIG. 5 shows another possible solution to the optimization problem, in which charging of the energy storage device 2 by way of the range extender 4 is advantageously not provided or required. In principle, FIG. 5 corresponds to FIG. 4, with the difference that the operating plan 19 in FIG. 5 provides for the energy storage device 2 to be fully charged at the charging station 28. Both possible operating plans 19, i.e., relating to FIG. 4 and FIG. 5, may be displayed to the user by way of the input device 27, wherein the user may specify which of these two operating plans 19 is to be implemented at the start of the journey or at the latest when reaching the charging station 28. For example, the user may prefer the operating plan 19 shown in FIG. 4 if the user is currently under time pressure, as the procedure according to the operating plan 19 shown in FIG. 5 requires more time due to the planned charging of the energy storage device 2.

In the last step 9 of the method, control signals 29 may be generated by the control device 10 during the journey and output to the range extender 4 to implement the operating plan 19.

German patent application no. 102025103381.1, filed January 30, 2025, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for operating a range extender of a motor vehicle, the method comprising:
generating a drive torque by a traction motor of the motor vehicle using electrical energy stored in an energy storage device of the motor vehicle, the traction motor configured as an electrical machine;
charging the energy storage device by operation of an internal combustion engine of a range extender using a fossil fuel and by use of a generator of the range extender;
determining or recording a route plan relating to a route to be taken during a journey with the motor vehicle before or at a start of the journey;
determining an operating plan relating to the charging of the energy storage device during the journey by way of the range extender based on the route plan; and
executing the journey while implementing the operating plan.

2. The method according to claim 1, further comprising identifying at least one connection section of the route based on the route plan,
wherein determining the operating plan includes determining a charging section of the route,
wherein the charging of the energy storage device by way of the range extender takes place within the charging section, and
wherein the charging section at least largely or completely takes place within the at least one connection section.

3. The method according to claim 2, wherein the at least one connection section is located outside a populated area and/or a low emission zone.

4. The method according to claim 2, wherein determining the operating plan includes carrying out an optimization problem to maximize at least one variable, the at least one variable including a portion of the charging section located within the at least one connection section.

5. The method according to claim 4, wherein the optimization problem is carried out to determine at least further at least one timing variable, the at least one timing variable including a time and a duration of the at least one charging section.

6. The method according to claim 5, wherein the time is a start time of the at least one charging section.

7. The method according to claim 1, further comprising predicting a progression of a state of charge of the energy storage device along the route over time using the route plan,
wherein the operating plan is determined based on the progression of the state of charge of the energy storage device along the route over time.

8. The method according to claim 7, wherein predicting the progression of the state of charge of the energy storage device along the route over time is uses an average energy consumption of the motor vehicle.

9. The method according to claim 8, wherein the average energy consumption of the motor vehicle is based on historical data and/or empirical values.

10. The method according to claim 7, wherein the operating plan is determined such that the energy storage device is only charged during the journey by way of the range extender if the state of charge during the journey is not always greater than a predetermined charge limit value.

11. The method according to claim 10, wherein the charge limit value is fixed or changeable.

12. The method according to claim 1, wherein the route plan is determined by way of a navigation device.

13. The method according to claim 12, wherein the navigation device is a GPS-based navigation device.

14. The method according to claim 1, wherein the route plan comprises at least one charging station located along the route,
wherein determining the operating plan includes consideration of a possible charging of the energy storage device at the charging station.

15. The method according to claim 14, wherein if several possible operating plans are determined and at least one of the several possible operating plans includes charging of the energy storage device at the charging station, one of the at least one of the several possible operating plans is selected as the operating plan.

16. The method according to claim 1, wherein the motor vehicle includes an input device configured to receive a requirement specified by at least one user request directed to the operating plan,
wherein determining the operating plan considers the at least one user request.

17. A control device for a motor vehicle, the control device comprising:
a computer-readable storage medium having program code configured to perform a method comprising:
determining or recording a route plan relating to a route to be taken during a journey with the motor vehicle before or at a start of the journey; and
determining an operating plan relating to the charging of the energy storage device during the journey by way of a range extender of the motor vehicle based on the route plan,
wherein the motor vehicle comprises:
an electrical energy storage device configured to store electrical energy; and
a traction motor configured as an electrical machine, the traction motor configured to use the electrical energy stored in the energy storage device to generate a drive torque of the motor vehicle;
the range extender comprising an internal combustion engine and a generator,
wherein the energy storage device is configured to be charged by way of operation of the internal combustion engine using a fossil fuel and use of the generator.

18. A motor vehicle, comprising:
an electrical energy storage device configured to store electrical energy;
a traction motor configured as an electrical machine, the traction motor configured to use electrical energy stored in the energy storage device to generate a drive torque of the motor vehicle;
a range extender comprising an internal combustion engine and a generator; and
a control device comprising a computer-readable storage medium having program code configured to perform a method comprising:
determining or recording a route plan relating to a route to be taken during a journey with the motor vehicle before or at a start of the journey; and
determining an operating plan relating to the charging of the energy storage device during the journey by way of the range extender based on the route plan,
wherein the energy storage device is configured to be charged by way of operation of the internal combustion engine using a fossil fuel and use of the generator.
